(19) United States
(12) Patent Application Publication
(10) Pub. No.: US 2011/0037690 A1
(43) Pub. Date: Feb. 17, 2011

(54) ELECTRONIC ALBUM

(76) Inventor: Thomas Kelly, Stanton, IA (US)

Correspondence Address: LAW OFFICE OF JERRY D. HAYNES , P.A, P.O. Box 350392, Fort Lauderdale, FL, 33335, US

(21) Appl. No.: 12/539,765

(22) Filed: Aug. 12, 2009

(51) Int. Cl. G09G 5/00; G06F 3/041

(52) U.S. Cl. 345/156; 345/173; 345/184

(57) ABSTRACT

An electronic album for presenting media content comprises a cover member and a frame member. The cover member and the frame member are hingedly coupled to each other to facilitate opening and closing of the electronic album. The electronic album further comprises a data input port, a user interface unit, a processor, and a display screen. The data input port, the user interface unit and the display screen are integrated in the frame member and are electrically connected to the processor. The data input port is capable of receiving data associated with the media content. Further, the user interface unit is capable of receiving at least one user input thereon and the processor is configured to process the data based on the at least one user input. The display screen is configured to present the media content based on the processed data.

### FIELD OF THE DISCLOSURE

The present disclosure relates to an album, and more particularly to an electronic album for storing and presenting media content, such as images and videos.

### BACKGROUND OF THE DISCLOSURE

Digital cameras have obtained unprecedented popularity in the modern era. Unlike conventional cameras, digital cameras are capable of storing huge amounts of media content (such as images and videos) due to the presence of storage devices therein. Digital cameras are capable of presenting the images and videos directly to users thereof without the need of transferring said images and videos to a media sheet or a display device. Moreover, digital cameras are capable of conveniently transferring the images and the videos to other electronic devices such as computers or hard disks when storage capacity of the storage devices present in the digital cameras is exhausted.

The digital cameras offer an additional functionality of directly displaying media content stored therein without the need of transferring the media content to a display device. However, the screen of the digital cameras may not be large enough for a user to conveniently view the displayed media content, thereby necessitating for the transfer of the stored media content to a device, such as a computer or a communication device having a larger display screen. The user may transfer the media content to the computer or the communication device to view them clearly.

However, usage of computers and the communication devices for storing and viewing the media content may have certain disadvantages. Specifically, for the purpose of sharing the media content stored in the computer with anyone else, the user may be required to transport the said computer from one location to another. However, the computer may be too bulky and inconvenient to carry. Moreover, the computer and the communication device may contain user's personal data that the user may not wish to share with anyone else. Additionally, a computer may not be affordable by everyone and many people may find the computers and the communication devices inconvenient to operate. Alternatively, the user may print the images in a conventional photo laboratory to view them clearly; however such an exercise is expensive when the user has hundreds of images to print.

Accordingly, there is a need for a device that is capable of presenting images and videos clearly. Further, there is a need for a device that is cost effective. Furthermore, there is a need for device that is portable and convenient to use.

### SUMMARY OF THE DISCLOSURE

In view of the foregoing disadvantages inherent in the prior art, the general purpose of the present disclosure is to provide a device for presenting images and videos, configured to include all the advantages of the prior art, and to overcome the drawbacks inherent therein.

An object of the present disclosure is to provide a device for presenting images and videos clearly.

Another object of the present disclosure is to provide a cost effective device for presenting images and videos.

Yet another object of the present disclosure is to provide a portable and user friendly device for presenting images and videos.

In light of the above objects, in one aspect of the present disclosure, an electronic album for presenting media content is disclosed. The electronic album comprises a cover member and a frame member. The cover member and the frame member are hingedly coupled to each other to facilitate opening and closing of the electronic album. The electronic album further comprises a data input port, a user interface unit, a processor, and a display screen. The data input port, the user interface unit and the display screen are integrated in the frame member and are electrically connected to the processor. The data input port is capable of receiving data associated with the media content. Further, the user interface unit is capable of receiving at least one user input thereon and the processor is configured to process the data based on the at least one user input. The display screen is configured to present the media content based on the processed data.

In another aspect of the present disclosure, the user interface unit comprises a touch screen unit. The touch screen unit is capable of receiving the at least one user input upon touching the display screen of the electronic album. The touch screen unit enables the user to select at least one option for presenting the media content, thereby facilitating operation of the electronic album in a convenient and user friendly manner.

In yet another aspect of the present disclosure, the user interface unit comprises a plurality of mechanical control buttons integrated in the frame member. Each of the plurality of mechanical control buttons is capable of receiving the at least one user input for selecting at least one option for presenting the media content. The selection of the at least one option by using the plurality of mechanical buttons provides a user friendly user interface for operating the electronic album.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, in which:

FIG. 1A illustrates a perspective view of an electronic album in an open position, in accordance with an embodiment of the present disclosure;

FIG. 1B illustrates a perspective view of the electronic album of FIG. 1A with an option selected on a menu thereof, in accordance with an embodiment of the present disclosure;

FIG. 1C illustrates a perspective view of the electronic album of FIGS. 1A and 1B in a closed position, in accordance with an embodiment of the present disclosure; and

FIG. 2 illustrates a perspective view of an electronic album in an open position, in accordance with another embodiment of the present disclosure.

Like reference numerals refer to like parts throughout the description of several views of the drawings.

### DETAILED DESCRIPTION OF THE DISCLOSURE

For a thorough understanding of the present disclosure, reference is to be made to the following detailed description, including the appended claims, in connection with the above-described drawings. Although the present disclosure is described in connection with exemplary embodiments, the present disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the terms, “a” and “an” herein do not denote a limitation of quantity, but rather denote the presence of at least one of the referenced item.

The present disclosure provides an electronic album having an external appearance of a conventional photo album. The disclosed electronic album is capable of opening in a book-like manner. The electronic album may be used to present media content, such as digital images and videos stored therein to a user. The media content may be stored in the electronic album by means of a removable or a permanent storage device. The digital images and videos may be transferred to the electronic album through a digital camera, a pen drive, a hard disk, a computer, and the like.

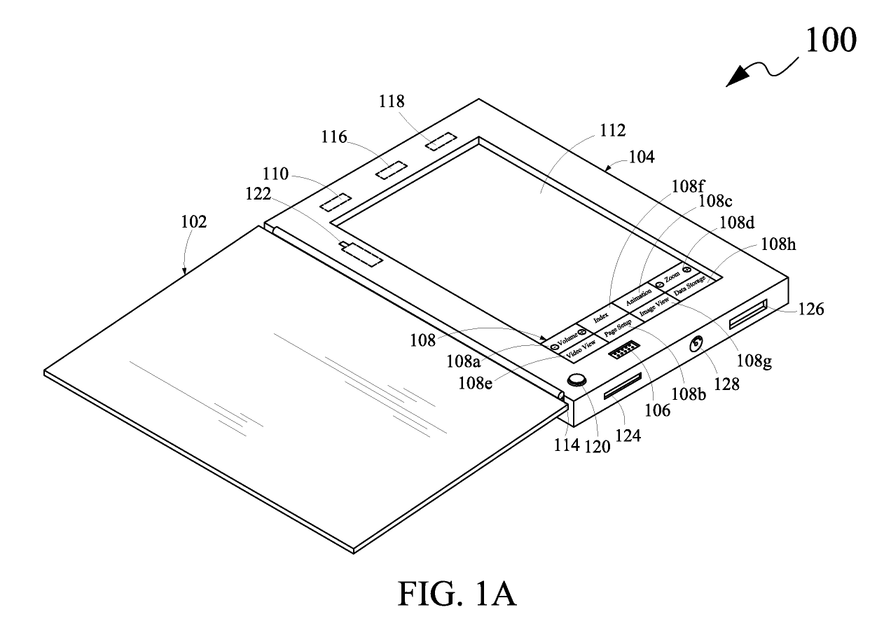

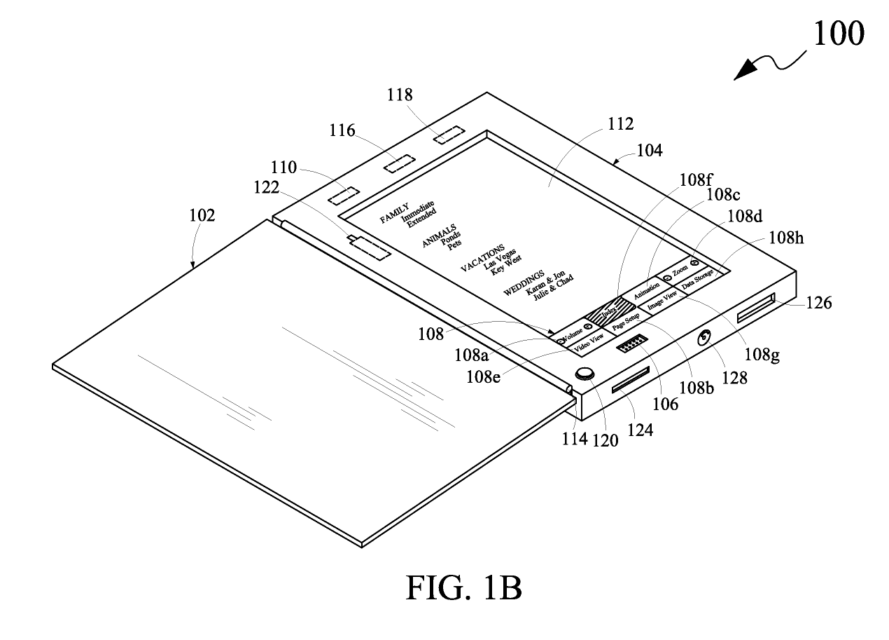

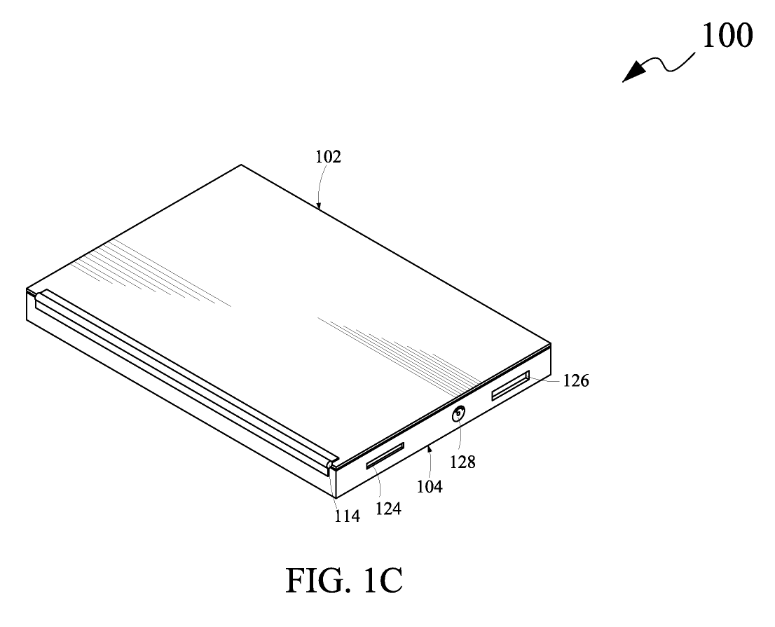

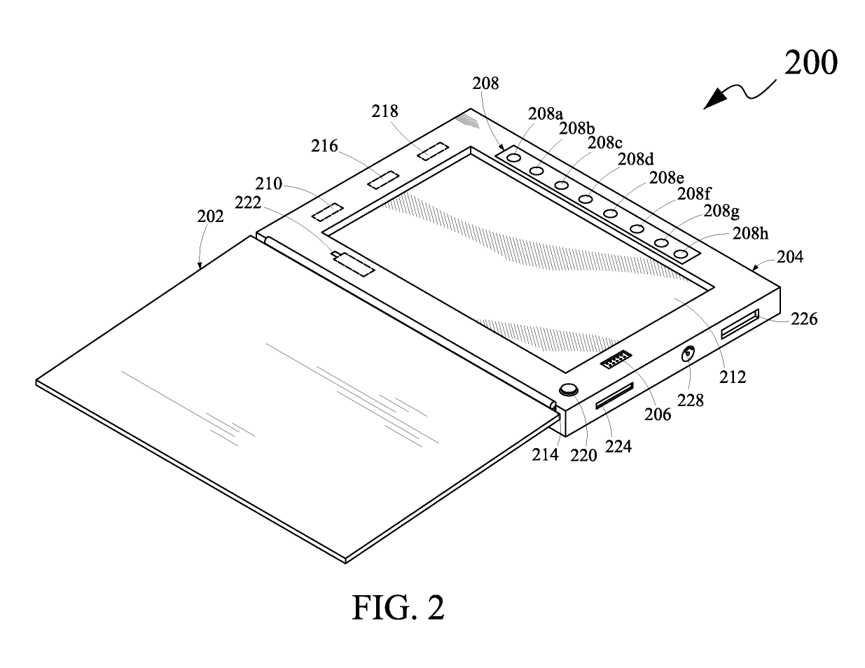

Referring to FIGS. 1A, 1B, 1C and 2, various views of an electronic album, such as an electronic album 100 and an electronic album 200 having a book-like configuration are shown in accordance with various embodiments of the present disclosure. Due to the book-like configuration thereof, the electronic album is capable of assuming an open position and a closed position similar to a book. Specifically, FIGS. 1A, and 1B illustrate an open position, and FIG. 1C illustrates a closed position of the electronic album 100 in accordance with an embodiment of the present disclosure. Further, FIG. 2 illustrates an open position of the electronic album 200 in accordance with another embodiment of the present disclosure.

Referring to FIGS. 1A and 1B and 1C, the electronic album 100 includes a cover member 102, a frame member 104, a data input port 106, a user interface unit 108, a processor 110, and a display screen 112. The cover member 102 may be hingedly coupled to the frame member 104 by means of a hinge mechanism, such as a hinge mechanism 114. The hinged coupling of the frame member 104 with the cover member 102 facilitates a pivotal movement of the cover member 102 with respect to the frame member 104, thereby enabling the electronic album 100 to assume one of an open position and a closed position. It would be evident to a person skilled in the art that the cover member 102 and the frame member 104 may be hingedly coupled together using any hinge mechanisms known in the art such as a continuous hinge, a strap hinge, and the like. Further, for the purpose of the present description, the shape of the cover member 102 and the frame member 104 is assumed to be rectangular, thereby imparting a rectangular shape to the electronic album 100. However, it will be evident to a person skilled in the art that the electronic album 100 may assume an elliptical shape, a circular shape or any other shape known in the art without deviating from the scope of the present disclosure. Further, in an example, the electronic album 100 may have dimensions of about 11.5 inches by about 10 inches. However, it will be evident to a person skilled in the art that the electronic album 100 may have dimensions larger or smaller than the dimensions mentioned herein.

The data input port 106 may be integrated in the frame member 104. The data input port 106 is capable of receiving data from an external source such as a flash drive, a hard disk, a computer, a digital camera, and the like. Examples of the data input port 106 may include, but are not limited to, a Universal Serial Bus (USB) port and the like. The data received by the data input port 106 may be associated with the media content to be presented by the electronic album 100. The data is at least one of a video data, an image data, an audio video data, and an audio data. In an embodiment of the present disclosure, the data received by the data input port 106 may be stored in the electronic album 100. Specifically, the electronic album 100 may include a memory unit, such as a memory unit 116 electrically connected to the processor 110. The memory unit 116 is configured to store the received data, such as a variety of images and videos, for the purpose of presenting media content associated with the received data on the electronic album 100. The memory unit 116 may include a memory know in the art, such as a hard drive, flash memory, and the like. The memory unit 116 may be permanently contained within the electronic album 100 for storing the data received by the data input port 106.

For the purpose of this description, the data refers to all the digital images, audio data, audio video data, and video data received by the data input port 106, while the media content refers to that portion of the received data which is to be presented by the electronic album 100. For example, the data including a variety of images and videos may be transferred to the electronic album 100 by means of the data input port 106. However, a portion of the transferred data, such as few digital images may be selected for the purpose of being displayed on the display screen 112 of the electronic album 100. Such selected portion of the transferred data may be referred to as the media content.

The user interface unit 108 may be integrated in the frame member 104. The user interface unit 108 may enable a user to interact with the electronic album 100. Specifically, the user interface unit 108 is capable of receiving at least one user input for facilitating control of at least one of a volume, a page setup, an animation, a media content zoom, a video view, an index, an image view, and a data storage in the electronic album 100.

In the present embodiment, the user interface unit 108 includes a touch screen unit capable of receiving the at least one user input upon touching the display screen 112. The user interface unit 108, specifically, the touch screen unit comprises options for control of at least one of volume, a page setup, an animation, a media content zoom, a video view, an index, an image view, and data storage. As illustrated in FIG. 1, the user interface unit 108 may include locations on the display screen 112 for selecting options for controlling volume (marked as 108a), page setup (marked as 108b), animation (marked as 108c), zoom (marked as 108d) of the media content, video view (marked as 108e), indexing (marked as 108f), image view (marked as 108g), and data storage (marked as 108h).

Control of the volume 108a may be used to control an output of an electro-acoustic transducer 118 integrated in the frame member 104 of the electronic album 100. The output of the electro-acoustic transducer 118 may be in the form of an audio signal. Further, the electro-acoustic transducer 118 may be electrically connected to the processor 110. Example of the electro-acoustic transducer 118 may be a speaker unit. Controlling the page setup 108b may enable the user to configure page properties such as size, appearance, theme, and other formatting of the media content such as images in the electronic album 100. Further, controlling the animation 108c may facilitate in animated turning of pages. Controlling the zoom 108d may facilitate in zooming in and zooming out the media content, such an image or a video. Further, the video view 108e may facilitate controlling the presentation of a video on the display screen 112. Controlling the Index 108f may facilitate categorization of the data received from the external source or stored in a memory unit 116. Using the option of Index 108f, the user may categorize or index the data into multiple folders and subfolders. For example, referring to FIG. 1B, the data may be categorized into folders such as Family, Animals, Vacations, and Weddings. Further, the “Family” folder may have subfolders such as “Immediate” and “Extended.” The “Animals” folder may have subfolders such as “Pond” and “Pets.” The “Vacation” folder may have subfolders such as “Las Vegas” and “Key West”; and the “Weddings” folder may have subfolders such as “Karen and Jon” and “Julie and Chad.” The folders and subfolders may be scrolled up or down by the user to find an appropriate folder or a subfolder. In an embodiment of the present disclosure, the folders and subfolders may be scrolled up or down by means appropriate buttons (not shown) configured on the frame member 104. Further, the image view 108g may be controlled for viewing images on the display screen 112, and the data storage 108h for storing the data received by the data input port 106 in the memory unit 116 of the electronic album 100.

The user may select one or more options from the user interface unit 108 for presenting the media content on the display screen 112. Specifically, the external source such as the flash drive may be plugged into the data input port 106 to receive the data present in the flash drive, and thereafter at least one option such as zoom, index, volume, and the like may be selected on the user interface unit 108.

The processor 110 is integrated in the frame member 104 of the electronic album 100 and is electrically connected to the data input port 106 and the user interface unit 108. The processor 110 is configured to process the data based on the at least one user input received on the user interface unit 108. For example, selection of the option of the data storage 108h on the user interface unit 108 may enable the processor 110 to control the storage of the data in the memory unit 116, and selection of the image view 108g may enable the processor 110 to control presenting of images/video on the display screen 112. Moreover, the processor 110 may control animated turning of pages containing the media content upon the user selecting the option of the animation.

The display screen 112 may be integrated in the frame member 104 and is electrically connected to the processor 110. The display screen 112 is configured to present the media content to the user. In an embodiment of the present disclosure, the display screen 112 is configured to display a menu containing options for controlling volume, page setup, animation, media content zoom, video view, indexing, image view, and data storage. The display screen 112 may display the menu upon the electronic album 100 assuming the open position. In other words, the electronic album 100 may be automatically turned on upon opening the electronic album 100. Alternatively, the electronic album 100 may be turned on by means of power ON/OFF button, such as a power ON/OFF button 120 configured on the frame member 104.

Further, the display screen 112 is configured to present multiple images and videos simultaneously. For example, the display screen 112 may present four images simultaneously in a thumbnail view. Moreover, the display screen 112 may include an option for allowing the user to either turn to a subsequent page displaying thumbnail views of subsequent images. Additionally, the display screen 112 may present the option of image view 108g for expanding a selected image to view the selected image in a full screen view on the display screen 112. In an embodiment of the present disclosure, the display screen 112 is capable of presenting a video data associated with the selected image. Specifically, the display screen 112 may include an icon (not shown) displayed on an image, the icon showing that the image is associated with a corresponding video. The image may be selected for playing the video associated with the image on the display screen 112.

Additionally, the electronic album 100 includes at least one power source 122 integrated in the frame member 104. The at least one power source 122 may be electrically connected to the processor 110 and may provide power for operation of various components, such as the display screen 112, the processor 110, and the like of the electronic album 100. Examples of the at least one power source 122 may include, but are not limited to a rechargeable battery, a non-rechargeable battery, and the like. In an embodiment of the present disclosure, the electronic album 100 may include a power supply input port, such as a power supply input port 124 for plugging-in the electronic album 100 to the direct electric supply. In the present embodiment, the power supply input port 124 is shown to be configured at a side wall of the frame member 104. However, it will be evident to a person skilled in the art that the power supply input port 124 may be configured at any other location on the frame member 104.

The electronic album 100 may also include a storage card slot, such as a slot 126. The slot 126 may be configured to receive a storage card containing the data associated with the media content. The electronic album 100 may also include a headphone port, such as a headphone port 126 for receiving a headphone plug (not shown) therein. The headphone port 126 may be electrically connected to the processor 110 for facilitating production of sound while presenting the audio or the audio-video media content. In the present description, the headphone port 126 is shown to be configured on a side-wall (not numbered) of the frame member 104. However, it will be evident to a person skilled in the art that the headphone port 126 may be configured at any other location on the frame member 104 that may be easily accessible for plugging-in the headphone plug.

In use, a user may open the electronic album 100 by pivotally moving the cover member 102 away from the frame member 104. In an embodiment of the present disclosure, electronic album 100 may be automatically turned on upon opening, i.e. by pivotally moving the cover member 102 away from the frame member 104. Alternatively, the user may power on the electronic album 100 by pressing the power ON/OFF button 120 configured on the frame member 105. Upon powering on the electronic album 100, the display screen 112 may be presented to the user such that the display screen 112 may include a menu of various options for presenting or storing the data. For example, as illustrated in FIG. 1A, the display screen 112 may include options, such as the volume 108a (up or down), the page setup 108b, the animation 108c, the zoom 108d (in or out), the video view 108e, the index 108f, the image view 108g, and the data storage 108h.

Further, as shown in FIG. 1B, the option of the index 108f may be selected by the user for presenting the index of various folders and subfolders of the data saved in the electronic album 100. The user may scroll up or down and may select a folder or a subfolder. Upon selecting a subfolder, the display screen 112 may display multiple images, for example, four images simultaneously contained in the selected subfolder. The multiple images may be displayed in a thumbnail view. The user may turn to a subsequent page displaying thumbnail views of subsequent images by means of the option of a ‘next page/previous page option’ (not shown) displayed on the display screen 112. Alternatively or additionally, ‘next page/previous page option’ may be provided by means of buttons (not shown) configured on the frame member 104. Further, the user may select the thumbnail view of an image of the multiple images to view an expanded view of the image. In an embodiment of the present disclosure, the user may also view a video data associated with an image by selecting the image.

When not in use, the electronic album 100 may be closed. Referring to FIG. 1C, the closed position of the electronic album 100 is illustrated. In the closed position, the cover member 102 may be moved pivotally to cover the frame member 104. Specifically, the hinge mechanism 114 between the cover member 102 and the frame member 104 facilitates the pivotal movement of the cover member 102, thereby enabling the electronic album 100 to assume one of the open position and the closed position. In an embodiment of the present disclosure, the electronic album 100 may be automatically switched off upon assuming the closed position. Alternatively, the electronic album 100 may be switched off by means of the power ON/OFF button 120 configured on the frame member 104.

Referring to FIG. 2, the electronic album 200 is illustrated in accordance with another embodiment of the present disclosure. Specifically, FIG. 2 illustrates an open position of the electronic album 200. The electronic album 200 is capable of presenting the media content, such as the images and the videos. The electronic album 200 includes a cover member 202, a frame member 204, a data input port 206, a user interface unit 208, a processor 210, and a display screen 212. The cover member 202 may be hingedly coupled to the frame member 204 by means of a hinge mechanism 214 similar to the hinge mechanism 114. The electronic album 200 also includes a memory unit 216.

The electronic album 200 is similar to the electronic album 100 (of FIGS. 1A, 1B and 1C) with an exception that the user interface unit 208 of the electronic album 200 includes a plurality of mechanical control buttons instead of the touch screen unit of the electronic album 100, as explained with reference to FIGS. 1A and 1B. Specifically, the cover member 202, the frame member 204, the data input port 206, the processor 210, the display screen 212, the hinge mechanism 214, the memory unit 216, an electro-acoustic transducer 218, at least one power source unit 222, an input port 224, a slot 226 for storage card, and a headphone port 228 for receiving a headphone plug of the electronic album 200 are similar to the cover member 102, the frame member 104, the data input port 106, the processor 110, the display screen 112, the hinge mechanism 114, the memory unit 116, the electro-acoustic transducer 118, a power ON/OFF button 120, at least one power source unit 122, the input port 124, the slot 126 for storage card, and the headphone port 128, respectively of the electronic album 100. Accordingly, the description of various components of the electronic album 200, such as the cover member 202, the frame member 204, the data input port 206, the processor 210, the display screen 212, the hinge mechanism 214, the memory unit 216, an electro-acoustic transducer 218, a power ON/OFF button 220, at least one power source unit 222, an input port 224, a slot 226 for storage card, and a headphone port 228 is omitted herein for the sake of brevity of description. Further, it will be understood to a person skilled in the art that the electronic album 200 is capable of assuming a closed position in a manner similar to the electronic album 100. According an illustration and the description for the closed position of the electronic album 200 is omitted from the present description.

However, the user interface unit 208 of the electronic album 200 includes the plurality of control buttons, such as buttons 208a, 208b, 208c, 208d, 208e, 208f, 208g, and 208h electrically connected to the processor 210. Each of the plurality of mechanical control buttons may be integrated in the frame member 204. The plurality of control buttons are adapted to receive the at least one user input thereon for selecting various options in the electronic album 200. Specifically, operating the buttons 208a, 208b, 208c, 208d, 208e, 208f, 208g, and 208h controls volume, page setup, animation, media content zoom, video view, indexing, image view, and data storage, respectively in the electronic album 200. Moreover, in the present embodiment, the display screen 212 may be a Liquid Crystal Display (LCD).

The electronic album, such as the electronic album 100 and the electronic album 200, explained in conjunction with FIGS. 1A, 1B, 1C and 2 may be advantageously used for clearly presenting media content, such as images, videos, or audio video data. The disclosed electronic album includes a user interface unit that facilitates a user-friendly access to the electronic album. Specifically, the user interface unit may be a touch screen unit or a plurality of buttons that enables a user to conveniently access various features of the electronic album. Moreover, the disclosed electronic album may be directly connected to a printer, thereby enabling a user to take printout of the media content, such as images stored therein. The electronic album is also capable of playing videos associated with images. Additionally, the electronic album provides a functionality of zooming-in or zooming-out the images stored therein. Further, the size and the shape of the electronic album are such that the electronic album is easily portable. Preferably, the size and shape of the electronic album disclosed herein are similar to that of a conventional photo album.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present disclosure.

What is claimed is:

1. An electronic album for presenting media content, the electronic album comprising:
a frame member;
a cover member hingedly coupled to the frame member to facilitate opening and closing of the electronic album;
a data input port integrated in the frame member, the data input port capable of receiving data associated with the media content;
a user interface unit integrated in the frame member, the user interface unit capable of receiving at least one user input;
a processor integrated in the frame member, the processor electrically connected to the data input port and to the user interface unit, wherein the processor is configured to process the data based on the at least one user input; and
a display screen integrated in the frame member, the display screen electrically connected to the processor and configured to present the media content based on the processed data.

2. The electronic album of claim 1, wherein the user interface unit is a touch screen unit capable of receiving the at least one user input upon touching the display screen.

3. The electronic album of claim 2, wherein the user interface unit comprises options for control of at least one of a volume, a page setup, an animation, a media content zoom, a video view, an index, an image view, and a data storage.

4. The electronic album of claim 1, wherein the user interface unit comprises a plurality of mechanical control buttons integrated in the frame member, each of the plurality of mechanical control buttons adapted to receive a user input of the at least one user input thereon.

5. The electronic album of claim 4, wherein the plurality of mechanical control buttons are electrically connected to the processor, each of the plurality of the mechanical control buttons being capable of controlling at least one of volume, an animation, a page setup, media content zoom, video view, index, image view, and data storage upon receiving the at least one user input thereon.

6. The electronic album of claim 1, further comprising at least one memory unit electrically connected to the processor, the at least one memory unit capable of storing the data.

7. The electronic album of claim 1, further comprising at least one power source integrated in the frame member, the at least one power source being electrically connected to the processor.

8. The electronic album of claim 7, wherein the at least one power source is a rechargeable battery.

9. The electronic album of claim 1, wherein the data is at least one of a video data, an image data, an audio video data, and an audio data.

10. The electronic album of claim 1, further comprising at least one electro-acoustic transducer integrated in the frame member, the at least one electro-acoustic transducer being electrically connected to the processor.
